(19) United States
(12) Patent Application Publication
(10) Pub. No.: US 2017/0068522 A1
(43) Pub. Date: Mar. 9, 2017

(54) COMPUTER IMPLEMENTED SYSTEM AND METHOD FOR CREATING AN ENTERPRISE APPLICATION

(71) Applicant: NUWAFIN HOLDINGS LTD, DUBAI (AE)

(72) Inventor: NANDAKUMAR KRISHNAN NAIR, TRIVANDRAM (IN)

(21) Appl. No.: 14/846,687

(22) Filed: Sep. 4, 2015

(51) Int. Cl. G06F 9/45

(52) U.S. Cl. CPC G06F 8/443; G06F 8/433

(57) ABSTRACT

A computer implemented system and method for creating an enterprise model have been disclosed. The system includes an attribute flow layer that decides upon the attributes to be displayed during the implementation of the enterprise application. A validator validates the attributes to be displayed during implementation of the enterprise application. A rule executor governs at least the implementation and operation of the enterprise application and processes therein. A navigation flow layer correlates the processes of the enterprise application and implements the business logic corresponding to the processes. Further, a storage mechanism stores the information corresponding to the processes of the enterprise application. The attribute flow layer, validator, rule executor and storage mechanism are configured to be selectively migrated between a client nodule accessing the enterprise application and the server module implementing the enterprise application, based on the analysis of a tracker, thereby improving the performance of the enterprise application.

### BACKGROUND

Technical Field

The embodiments herein relates to a system, method and a computer program product that enable selective migration of predetermined functional components between client side and server side.

Description of the Related Art

Enterprise applications differ from one another in terms of their functionalities. The enterprise applications differ from one another in terms of the business entities they cater to, business processes they implement and the underlying business rules. However, despite the diversity in business processes, entities and rules, the technical layer remains unaltered for majority of the enterprise applications. However, none of the prior art solutions attempted to isolate the business function layer from the technical layer, thereby designing a reusable technical layer.

Over a period of time, a plurality of system software layers have evolved on top of the conventional operating system layer, thereby rendering the enterprise application development phase to be highly flexible. Further, with the advent of Service Oriented Architecture (SOA), users can choose to interact with the service layer, and further choose to abstract the workings of the underlying technical layer. Typically, Service Oriented Architecture (SOA) enables enterprise applications to be designed as interoperable and reusable (software) service components.

There was felt a need for a system/method that would efficiently exploit, the capabilities of SOA and generate enterprise applications having higher degrees of flexibility. There was also felt a need for a system/method which would provide for enterprise applications to be generated based on the business requirements defined from both functional view point and non-functional view point. Further, there was also felt a need for a system that would support collaborative development, deployment, execution and maintenance of enterprise applications. A system which would enable users, typically business (non-technical) users to build enterprise applications by wiring platform services with business rules, was not envisaged by any of the prior art systems. There was also felt a need for a system that employed rule based wiring.

The above mentioned shortcomings, disadvantages and problems are addressed herein and which will be understood by reading and studying the following specification.

### OBJECTIVES OF THE EMBODIMENTS

An object of the embodiments herein, is to provide a system that employs rule based wiring to crate enterprise applications.

Yet another object of the embodiments herein is to provide a system that exposes the functionalities of a business service, as per the definitions provided in the service contract, via a graphical user interlace, and a multi layered client platform continuum.

One more object of the embodiments herein is to provide a system that provides for seamless wiring (integration) of basic platform services with business rules, from both functional view point and nonfunctional view point.

Still a further object of the embodiments herein is to provide a system that provides for different layers of the enterprise application to be selectively incorporated either on the client side or the server side.

One more object of the embodiments herein is to provide a system that envisages a client platform multi layered continuum.

Still a further object of the embodiments herein is to provide a system that dynmically configures the enterprise application based on the analysis of the performance characteristics of the client device, and the application development platform.

Yet another object of the embodiments herein to provide a system that generates enterprise application deployment decisions dynamically, based on the analysis of the performance characteristics of the client device, and the application development platform.

Still a further object of the embodiments herein is to provide a system that enables design, development, deployment, execution and monitoring of enterprise application.

These and other objects and advantages of the embodiments herein will become readily apparent from the following detailed description taken in conjunction with the accompanying drawings.

### SUMMARY

The embodiments herein envisages a computer implemented enterprise application development platform for developing an enterprise application. The platform comprises an application development module. The application development module includes an attribute flow layer which is configured to decide upon the attributes to be displayed during the implementation of the enterprise application. The attribute flow layer is further configured to selectively fetch the attributes to be displayed, from a server module.

In accordance with the embodiments herein, the application development module further includes a validator configured to validate each of the attributes to be displayed at various instances of implementation of the enterprise application. The validator is further configured to validate the interactions between each of the attributes.

In accordance with the embodiments herein, the application development module further includes a rule executor having access to a plurality of validation rules and business logic corresponding to the processes to be executed in the enterprise application. The rules govern at least the implementation and operation of the enterprise application and processes therein.

In accordance with the embodiments herein, the application development module further includes a navigation flow layer configured to correlate the processes of the enterprise application and implement the respective business logic corresponding to the process, subsequent to the invocation of respective processes.

In accordance with the embodiments herein, the application development module further includes a storage mechanism configured to at least temporarily store the information corresponding to the processes of the enterprise application.

In accordance with the embodiments herein, the application development module further includes a tracker configured to track and analyze the performance of the attribute flow layer, validator, rule executor and storage mechanism, and recommend optimal configurations for the attribute flow layer, validator, rule executor and storage mechanism.

In accordance with the embodiments herein, the attribute flow layer, validator, rule executor and storage mechanism are configured to be selectively migrated between a client module accessing the enterprise application and the server module implementing the enterprise application, thereby improving the performance of the enterprise application.

In accordance with the embodiments herein, the system further comprises a display configuration module adapted to configure at least the attributes to be displayed at various instances of implementation of an enterprise application, the display configuration module adapted to reside within the client module.

In accordance with the embodiments herein, the system comprises a plurality of platform services configured to be resident on the server module implementing the enterprise application.

In accordance with the embodiments herein, the rule executor is configured to execute validation rules selected from the group consisting of attribute validation rules and entity validation rules.

The embodiments herein envisages a computer implemented method for developing an enterprise application. The method, in accordance with the embodiments herein comprises the following computer implemented steps: deciding upon the attributes to be displayed during the implementation of the enterprise application, and selectively fetching the attributes to be displayed, from a server module; validating each of the attributes to be displayed at various instances of implementation of the enterprise application, and validating the interactions between each of the attributes; correlating between the processes and implementing the respective business logic when the corresponding process is invoked in the enterprise application; at least temporarily storing the information corresponding to the processes of the enterprise application; and tracking and analyzing the performance of the enterprise application and recommending optimal configurations for improving the performance of the enterprise application.

In accordance with the embodiments herein, the steps at deciding, validating, correlating and temporarily storing are selectively migrated between a client module accessing the enterprise application and the server module implementing the enterprise application, in order to improve the performance of the enterprise application.

In accordance with the embodiments herein, the method further includes the step of configuring at least the attributes to be displayed at various instances of implementation of an enterprise application.

In accordance with the embodiments herein, the step of validating each of the attributes further includes the step of validating each of the entities corresponding to the attributes.

The embodiments herein discloses a non transitory computer readable medium having computer readable instructions stored thereupon, the computer readable instructions when executed by a processor, configured to cause a computer enabled device to implement a plurality of functionalities including the following: decide upon the attributes to be displayed during the implementation of the enterprise application, and selectively fetch the attributes to be displayed, from a server module; validate each of the attributes to be displayed at various instances of implementation of the enterprise application, and validate the interactions between each of the attributes; correlate between the processes and implement the respective business logic when the corresponding process is invoked in the enterprise application; at least temporarily store the information corresponding to the processes of the enterprise application; and track and analyze the performance of the enterprise application and recommend optimal configurations for improving the performance of the enterprise application.

In accordance with the embodiments herein, the computer readable instructions when executed by a processor, cause the computer enabled device to selectively migrate the functionalities in order to improve the performance of the enterprise application.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the description of the embodiments of the embodiments herein and the accompanying drawings in which:

FIG. 1 Illustrates a system level block diagram of a computer implemented enterprise application development platform, in accordance with the one embodiment herein;

FIG. 2 illustrates a flowchart comprising the steps involved in the method for creating an enterprise application, according to one embodiment herein;

FIG. 3 is a flowchart illustrating the interconnection between the various functional blocks described in FIG. 1, according to one embodiment herein;

FIG. 4 is a table illustrating the various sub-layers (and the corresponding functionalities) of the enterprise application development platform illustrated in FIG. 1, according to one embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The embodiments herein envisages a computer implemented enterprise application development platform 100. The platform 100, in accordance with the embodiments herein comprises an application development module 10. The application development module 10 provides for the creation of enterprise applications. The application development module 10 comprises an attribute flow layer 10A. The attribute flow layer 10A determines the attributes of the enterprise application, to be displayed during the implementation of the enterprise application. The attribute flow layer 10A is configured to be implemented either at the client end or at the server end, in the event that the enterprise application is implemented in client-server architecture. In accordance with the embodiments herein, the attribute flow layer 10A is configured to incorporate the decision making intelligence to decide upon the attributes to be fetched/received from the serve side. Alternatively, the attribute flow layer 10A can be made a part of the server-side, and in such a case the client device would display the attributes, which are fetched from the server-end.

In accordance with the embodiments herein, the application development module 10 further comprises a validator 10B configured to validate each of the attributes fetched by the attribute flow layer 10A. For example, the validator 10B can check whether ‘email syntax’ (email address being the attribute) is valid. Further, the validator 10B can be programmed to determine the authenticity for various possible attributes, such as text based attributes, numeric attributes, and the like. In accordance with the embodiments herein, in the event that the client side device is a trusted device, the validation is performed at the client-end, and the steps of validation need not be duplicated, thereby providing for prevention of redundancy, and enhanced performance.

In accordance with the embodiments herein, the application development module 10 further comprises a rule executor 10C having access to a plurality of validation rules and business logic corresponding to the processes to be executed in the enterprise application. For example, in case of an accounting enterprise application, if the account balance falls beyond a presser threshold, an alert message needs to be generated and dispatched to the corresponding handler. The rule executor 10C, in this case tracks and implements the rules for determining whether the current account balance falls beyond the threshold level, and also the rules governing the identification of the handler of the account and the transmittal of the alert message thereto.

In accordance with the embodiments herein, the application development module 10 further comprises a navigation flow layer 10D. The navigation flow layer 10D is configured to correlate all the processes of the enterprise application and subsequently implement the business logic corresponding to each of the processes, when the individual processes ate invoked during the execution of the enterprise application.

Further, a storage mechanism 10E is configured to cooperate with the client-side and the server side devices implementing the enterprise applications. The storage mechanism is configured to at least temporarily the data and the information to be exchanged between the client and the server, during the implementation of the enterprise application. The storage mechanism cooperates with the attribute flow layer 10A, validator 10B, rule executor 10C, and navigation flow layer 10D, to store any data and information relevant to the aforementioned modules. The storage mechanism 10E is typically located on the client side, thereby allowing a user accessing the client-side device to save his/her progress in terms of the corresponding actions/transactions.

In accordance with the embodiments herein, a tracker 12 cooperates with the attribute flow layer 10A, validator 10B, rule executor 10C, and navigation flow layer 10D, in order to track the performance of the aforementioned nodules under a plurality of computational loads. The tracker 12 is configured to track analyze and analyze the performance of each of the modules, and provide for the selective migration of the aforementioned modules between the client side device accessing an enterprise application and a server side device accessing the enterprise application.

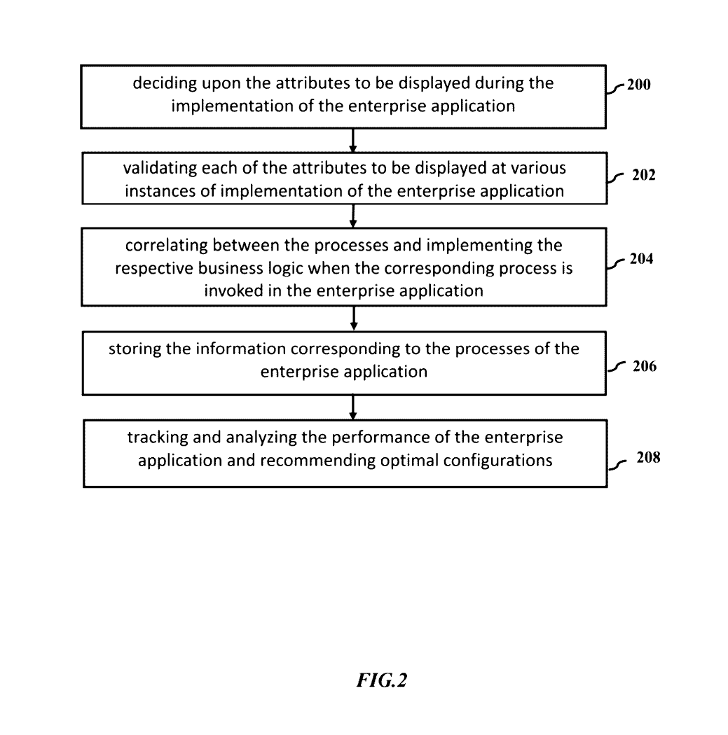

Referring to FIG. 2, there is shown a flowchart illustrating the steps involved in the method for creating an enterprise application. The method, in accordance with the embodiments herein comprises the following steps: deciding upon the attributes to be displayed during the implementation of the enterprise application, and selectively fetching, the attributes to be displayed, from a server module 200; validating each of the attributes to be displayed at various instances of implementation of the enterprise application, and validating the interaction between each of the attributes 202; correlating between the processes and implementing the respective business logic when the corresponding process is invoked in the enterprise application 204; at least temporarily storing the information corresponding to the processes of the enterprise application 206; and tracking and analyzing the performance of the enterprise application and recommending optimal configurations for improving the performance of the enterprise application 208.

In accordance with the embodiments herein, the steps of deciding, validating, correlating and temporarily storing are selectively migrated between a client module accessing the enterprise application and the server module implementing the enterprise application, in order to improve the performance Of the enterprise application.

In accordance with the embodiments herein, the method further includes the step of configuring at least the attributes to be displayed at various instances of implementation of an enterprise application.

In accordance with the embodiments herein, the step of validating each of the attributes further includes the step of validating each of the entities corresponding to the attributes.

Further, the embodiments herein envisages a non transitory computer readable medium having computer readable instructions stored thereupon, the computer readable instructions when executed by a processor, configured to cause a computer enabled device to implement a plurality of functionalities including the following: decide upon the attributes to be displayed during the implementation of the enterprise application, and selectively fetch the attributes to be displayed, from a server module; validate each of the attributes to be displayed at various instances of implementation of the enterprise application, and validate the interactions between each of the attributes; correlate between the processes and implement the respective business logic when the corresponding process is invoked in the enterprise application; at least temporarily store the information corresponding to the processes of the enterprise application; and track and analyze the performance of the enterprise application and recommend optimal configurations for improving the performance of the enterprise application.

In accordance with the embodiments herein, the computer readable instructions when executed by a processor, cause the computer enabled device to selectively migrate the functionalities in order to improve the performance of the enterprise application.

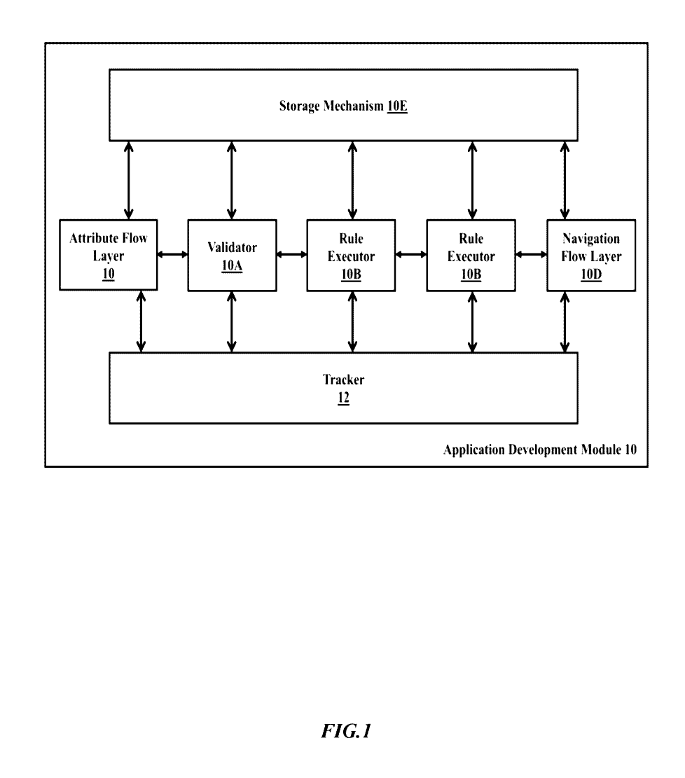

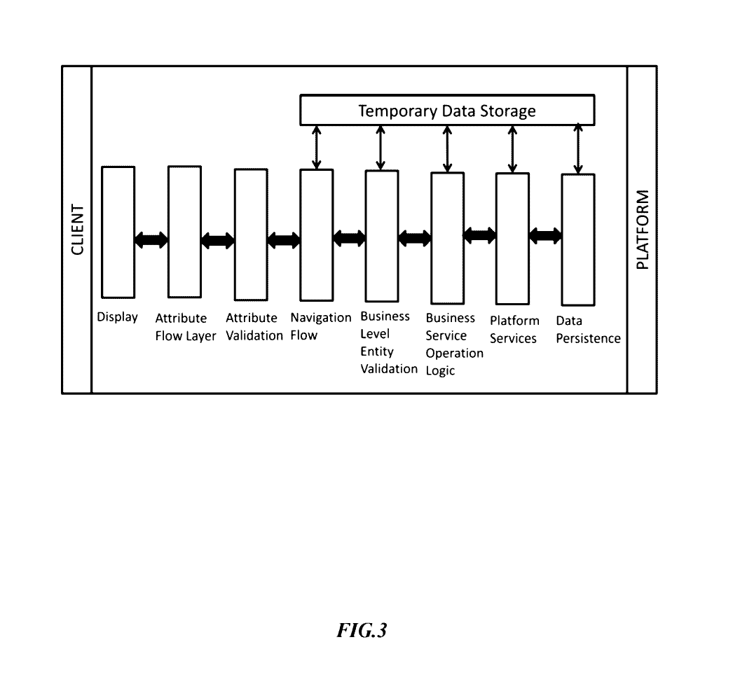

Referring to FIG. 3, there is shown a flowchart illustrating the interconnections between the various components illustrated in FIG. 1. The functional layer ‘display’ as shown in FIG. 3 renders the business services using a graphical user interface (GUI). This layer always resides in the client (a browser or a mobile device). The display module receives inputs from a user to execute business services and subsequently presents the output of the executed business services to the user. Further, as shown in FIG. 3 the attribute flow layer determines the attributes of an entity that are to be displayed using the GUI. The attribute flow layer can reside in the client side (i.e.) client has the intelligence to decide which attributes have to be fetched from the platform side. Alternatively, this layer can also reside on the platform side (i.e.) client is a dumb display-only terminal.

Further, the attribute validation validates an attribute once the values of the attribute have been filled in by the user. The validation can occur in the client and the validated data (sterile data) can be sent back to the platform. Alternatively, non-sterile data can be sent to the platform and the platform will then perform the necessary validations from the input data. The attribute validation layer also incorporates mechanisms to avoid duplicate validations, i.e., if the user input data has already been validated by the client, the platform avoids redoing those validations. Further, the attribute validation layer also addresses security issues so that erroneous data is not sent for processing as sterile data, by a malicious client.

Further, the ‘navigation flow’ layer determines the sequence of steps to be undertaken to complete a particular action. For instance, while updating an entity, after the attribute values of that entity have been filled in and validated, the next step is to invoke the appropriate business service with the correct parameters. The navigation flow layer can also reside in the client (i.e.) an intelligent client is aware of which business service to be invoked and the invocation parameters. Alternatively, it can also reside in the platform and client can just pass the information back to the platform.

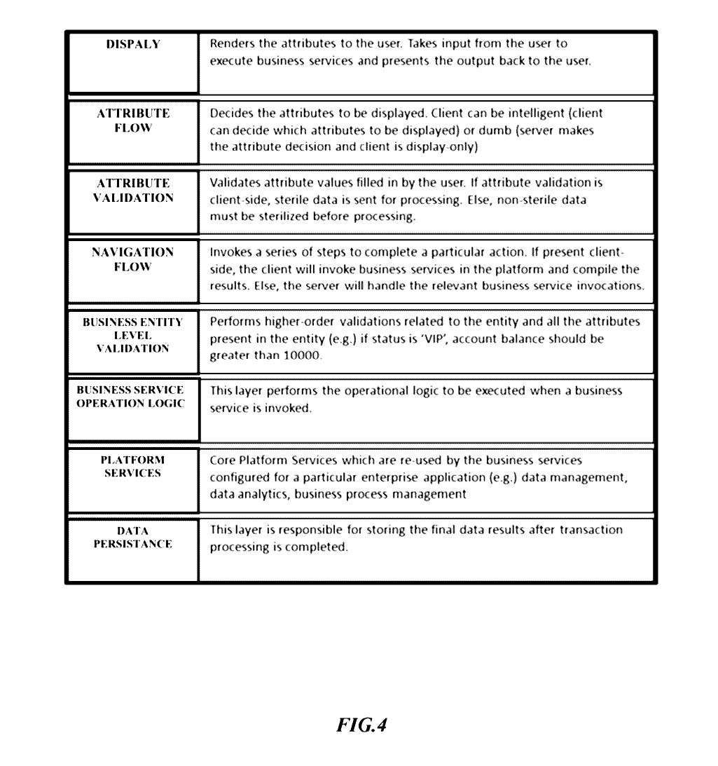

Further, the ‘business entity level validation’ layer determines the higher order validations that need to be performed. For instance, the ‘customer-id’ should be unique is a higher order validation at the entity level. Such higher order validations can reside in the client or the platform. Further, the business service operation logic layer holds the operational logic to be executed when a business service is invoked. For instance, once a customer attribute is created, a welcome email needs to be sent, and the business service operation logic layer takes care of such functionality. The ‘platform services’ layer includes, but is not restricted to data management, business process management, data analytics etc. This layer resides in the platform under all design and implementation scenarios. The ‘data persistence’ layer stores the final data after transaction processing is completed. This layer always resides in the platform. Depending on the performance characteristics of the installation, these functional layers can be configured to reside in either the client or the platform. As multiple layers are added to the client, the client becomes loaded in terms of the functionality (thicker), reducing the processing capacity required by the platform. Further, FIG. 4 is a table illustrating the various contextual sub-layers of the system illustrated in FIG. 1.

The technical advantages of the embodiments herein include the realization of a client platform multi layered continuum which is in the form of an enterprise application. The system envisaged by the embodiments herein exposes the functionalities of a business service, as per the definitions provided in the service contract, via a graphical user interface, and the multi layered client platform continuum. The system further provides for seamless wiring (integration) of basic platform services with business rules, from both functional view point and nonfunctional view point. The system of the embodiments herein enables different layers of the enterprise application to be selectively incorporated either on the client side or the server side. Still, a further object of the embodiments herein is to provide a system that dynamically configures the enterprise application based on the analysis of the performance characteristics of the client device, and the application development platform. The system also generates enterprise application deployment decisions dynamically, based on the analysis of the performance characteristics of the client device, and the application development platform. Further, the system enables design, development, deployment, execution and monitoring of enterprise applications.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications.

Although the embodiments herein are described with various specific embodiments, it will be obvious for a person skilled in the art to practice the embodiments herein with modifications.

It is also to be understood that the following claims are intended to cover all of the generic and specific features of the embodiments described herein and all the statements of the scope of the embodiments which as a matter of language might be said to fall there between.

What is claimed is:

1. A computer implemented application development platform for creating an enterprise application, said platform comprising an application development module, said application development module comprising:
an attribute flow layer configured to decide upon the attributes to be displaced during the implementation of the enterprise application, said attribute flow layer configured to selectively fetch the attributes to be displayed, from a server module;
a validator configured to validate each of the attributes to be displayed at various instances of implementation of the enterprise application, said validator further configured to validate the interactions between each of the attributes;
a rule executor having access to a plurality of validation rules is and business logic corresponding to the processes to be executed in the enterprise application, said rules governing at least the implementation and operation of the enterprise application and processes therein;
a navigation flow layer configured to correlate the processes of the enterprise application and implement the respective business logic corresponding to the process, subsequent to the invocation of respective processes;
a storage mechanism configured to at least temporarily store the information corresponding to the processes of the enterprise application;
a tracker configured to track and analyze the performance of said attribute flow layer, validator, rule executor and storage mechanism, and recommend optimal configurations for said attribute flow layer, validator, rule executor and storage mechanism;
wherein said attribute flow layer, validator, rule executor and storage mechanism are configured to be selectively migrated between a client module accessing the enterprise application and the server module implementing the enterprise application, based on the analysis of the tracker, thereby improving the performance of the enterprise application.

2. The system as claimed in claim 1, wherein said system further comprises a display configuration module adapted to configure at least the attributes to be displayed at various instances of implementation of an enterprise application, said display configuration module adapted to reside within the client module.

3. The system as claimed in claim 1, wherein said system comprises a plurality of platform services configured to be resident on the server module implementing the enterprise application.

4. The system as claimed in claim 1, wherein said rule executor is configured to execute validation rules selected from the group consisting of attribute validation rules and entity validation rules.

5. A computer implemented method for creating an enterprise application, said method comprising the following computer implemented steps:
deciding upon the attributes to be displayed during the implementation of the enterprise application, and selectively fetching the attributes to be displayed, from a server module;
validating each of the attributes to be displayed at various is instances of implementation of the enterprise application, and validating the interactions between each of the attributes;
correlating between the processes and implementing the respective business logic when the corresponding process is invoked in the enterprise application;
at least temporarily storing the information corresponding to the processes of the enterprise application;
tracking and analyzing the performance of the enterprise application and recommending optimal configurations for improving the performance of the enterprise application;
wherein said steps of deciding, validating, correlating and temporarily storing are selectively migrated between a client module accessing the enterprise application and the server module implementing the enterprise application, in order to improve the performance of the enterprise application.

6. The method as claimed in claim 5, wherein the method further includes the step of configuring at least the attributes to be displayed at various instances of implementation of an enterprise application.

7. The method as claimed in claim 5, wherein the step of validating each of the attributes further includes the step of validating each of the entities corresponding to the attributes.

8. A non transitory computer readable medium having computer readable instructions stored thereupon, the computer readable instructions when executed by a processor, configured to cause a computer enabled device to implement a plurality of functionalities including the following:
decide upon the attributes to be displayed during the implementation of the enterprise application, and selectively fetch the attributes to be displayed, from a server module;
validate each of the attributes to be displayed at various instances of implementation of the enterprise application, and validate the interactions between each of the attributes;
correlate between the processes and implement the respective business logic when the corresponding process is invoked in the enterprise application;
at least temporarily store the information corresponding to the processes of the enterprise application; and
track and analyze the performance of the enterprise application and recommend optimal configurations for improving the performance of the enterprise application;
wherein, said the computer readable instructions when executed by a processor, cause the computer enabled device to selectively migrate the functionalities in order to improve the performance of the enterprise application.
